(19) United States
(12) Patent Application Publication
(10) Pub. No.: US 2014/0306472 A1
(43) Pub. Date: Oct. 16, 2014

(54) LOW PROFILE LIFTING ASSEMBLY FOR MANAGING ELECTRICAL COMPONENTS DURING INSTALLATION AND SERVICE OF MACHINES

(71) Applicant: Caterpillar Inc., Peoria, IL (US)

(72) Inventors: Jeeva Manickam, Chennai (IN); Rajesh Sampath, Chennai (IN); Sivakumar Ramaiyan, Chennai (IN); Mohammad Umar Ahmad, Dubuque, IA (US)

(21) Appl. No.: 14/315,024

(22) Filed: Jun. 25, 2014

(51) Int. Cl. B66C 1/10

(52) U.S. Cl. CPC B66C 1/10
USPC 294/81.5

(57) ABSTRACT

The disclosure describes a lifting system for use with a hoist, comprising of at least one structural frame rail, attached to middle portions of cross members on the opposite ends of the frame rail, such that the two cross members are co-planar. Each end of the cross member is attached to an attachment assembly. The attachment assembly comprises of an extension link and a detachable pin member assembly. On end of extension link is attached to the cross member and the other end is provisioned to receive the pin member assembly. A lifting lug assembly is structured and arranged at the center of the frame rail towards the upper face of the rail, to connect an external hoist for lifting in vertical direction. The lifting system as described above provides an easy lifting mechanism for heavy objects, such as an alternator of the electric drive trucks.

### TECHNICAL FIELD

The present disclosure relates generally to a lifting system designed to lift a substantial component from a machine and more particularly to safely manage the heavy objects such as an alternator/generator, a motor, axle etc., from electric drive machines.

### BACKGROUND

Large machines, such as mining trucks, are known to employ electric drive propulsion systems to propel or retard the machine. Typically, an electric drive propulsion system includes an alternator, or other electrical power generator, powered by an internal combustion engine which drives an electric power generator, for example. The alternator, in turn, supplies electrical power to one or more electric drive motors connected to wheels of the machine. As these machines often work in dirt and mud, and require periodic servicing, oftentimes, the electrical units such as, alternator, electric motor, etc., are removed, repaired (or serviced) and reassembled during a normal course of service or repair. These electrical units are typically substantial in size, bulky and quite often very heavy. There is currently no special tool available to manage a wide variety of these components, using a single tool, for the removal, service and installation of the alternator and other large electrical components, particularly at the worksite. Therefore, it is required to have a low profile lifting system of lower weight for expeditious yet safe removal and moving of heavy electrical components.

U.S. Patent No. 2012/0272496 (the '496 patent) discloses a system and method for lifting a casing section, during servicing or maintenance of a gas turbine. Patent '496 discloses a lifting system to clutch and lift the top section vertically in relation to the bottom section. This lifting system can be used to lift the top cover to a limited height and require expensive and complex supporting members to hold the top cover in the elevated position. Moreover, the lifting system disclosed is not a standalone system to be lifted and move objects from one place to other.

A lifting system which may overcome one or more of these limitations and one that would be readily manufacturable would be desirable. Furthermore, an integrated lifting system which does not significantly add cost and one that does not increase the weight of the component to be lifted, and one which may be readily adaptable to many machine types to robustly secure a component is highly desirable.

### SUMMARY OF THE INVENTION

The disclosure describes, a lifting system for use with a hoist to exert an upward force on the lifting system associated with the lifting of a load, comprising of at least one structural frame rail, attached to middle portions of cross members on the opposite ends of the frame rail, such that the two cross members are parallel to each other and co-planar. A pair of attachment assemblies is attached to both cross members, such that each end of cross member is attached to an attachment assembly. The attachment assembly comprises of an extension link and a detachable pin member assembly. The extension link comprises of two cavities on each end, such that one cavity is used to connect the end of cross member therethrough and the other cavity for attaching a pin member assembly to secure the object to be lifted. A lifting lug is structured and arranged at the center of the frame rail towards the upper face of the rail, to connect an external hoist for lifting in vertical direction. The rail frame is structured and arranged to be in compressive force contact with the first and second cross members and the first and second cross members are structured and arranged to be in compressive force contact with each of the extension links of the first and second pairs of attachment assemblies in response to the load being applied to the attachment assemblies and corresponding upward force on the lifting lug assembly. A lifting system as described above provides an easy lifting mechanism for heavy objects, such as an alternator of the electric drive trucks.

### BRIEF DESCRIPTION OF THE DRAWINGS

FIG. 1 is a left side view of an electrical mining truck which possesses electrical components to be installed/removed using the present disclosure lifting system;

FIG. 2 is a perspective view of the truck of FIG. 1 with the bed lifted and the air, fuel, electrical and exhaust lines removed, to illustrate the typical field environment and space constraints associated with the use of the low profile lifting system to install and remove an alternator from a truck;

FIG. 3 is a perspective view of the lifting system of FIG. 2, showing the frame, cross member, lifting lug assembly, and detachable pin members etc.;

FIG. 4 is a partial exploded view of the lifting system shown in FIG. 3.

FIG. 5 is an exploded view of the lifting lug assembly shown in FIG. 4 depicting the mounting plate and frame rail details;

FIG. 6 is an exploded view showing the detachable pin, extension link, washer, and lock pin, and relationship therebetween; and

FIG. 7A and FIG. 7B, are diagrammatic partial views showing elements of the present disclosure lifting system assembly and specifically illustrating the usage of multi-lifting connections between view 7A and 7B.

### DETAILED DESCRIPTION

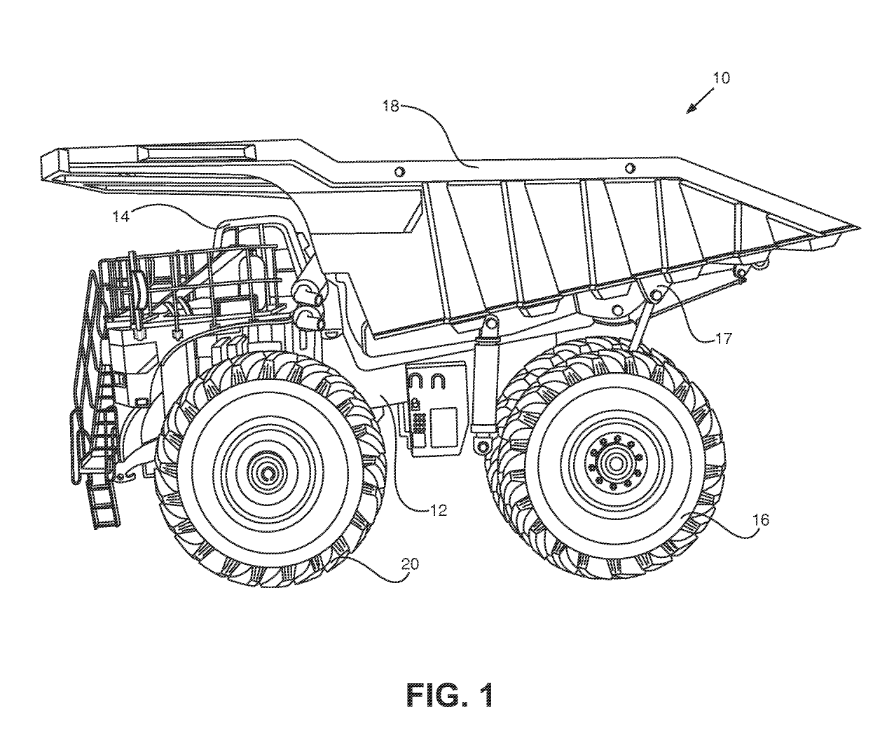

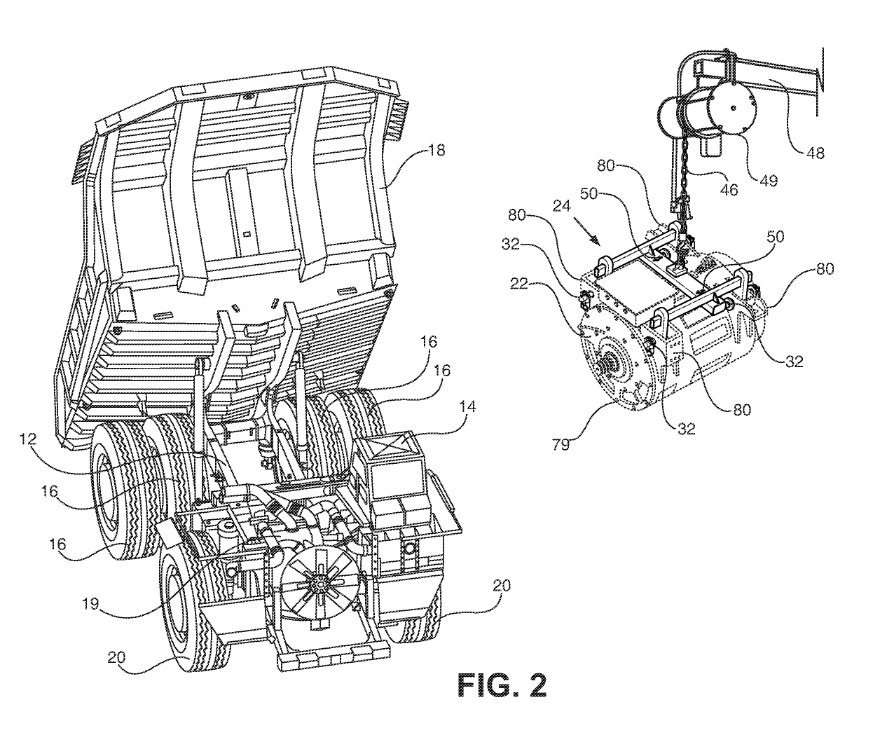

Referring to FIG. 1, an off-highway truck 10 having a load body 18, includes a frame 12 having rear wheels 16 and front wheels 20 mounted to axles (not shown) which in turn are mounted to the frame 12 as is customary. An operator's station 14, which is positioned adjacent an engine compartment 19 (FIG. 2), is mounted at one end of the frame 12. The off-highway truck 10 may include an electric powertrain (not shown) having an engine (not shown), for example, an internal combustion engine, for providing the off-highway truck 10 with mechanical energy. The engine (not shown) is operatively associated with an electric power generator (not shown), mounted within the engine compartment 19, and may drive the electric power generator (not shown) such that the electric power generator (not shown) converts the mechanical energy from the engine (not shown) into electric energy. Thus generated electric energy can be coupled to rear wheels 16, through electric drive motors (not shown). The load body 18 is pivotally attached to the frame 12 by a pair of body supports 17.

Referring to FIG. 2, as these trucks are continuously operated and are typically in harsh environments, periodic servicing of electrical systems is required. A typical electric system associated with truck 10 may include an alternator 22, drive motors (not shown), inverter (not shown), etc. These electrical components are heavy and may require careful attention during their assembly and disassembly. For example, an alternator 22 used in a large electric or hydraulic mining truck 10 may weigh more than 10,000 lbs.

In FIG. 2, certain components of the truck, such as a rectifier, grid, blower, inverter, etc., are not shown in order to illustrate the partially disassembled truck in preparation to receive the alternator 22. To lift or install the alternator 22 assembled on a truck 10, the load body 18 should be lifted such that it exposes the electrical component and then a hoist 49 may be positioned at a desired location, and allowed to lower chains 46. In an exemplary embodiment, a service truck (not shown) with hoist is used for this purpose. The service truck is parked at an appropriate location next to the truck 10. The chains 46 of the hoist 49 may be connected to a lifting system 24 which has been previously attached to the alternator 22, as will be described hereinbelow.

Lifting system 24 is mounted on the alternator 22, and the lifting system 24 along with the alternator 22 is supported by the cylindrical-shaped hoist 49. The hoist may be an electric, 10 ton hoist and supported by a foundational member 48 such as a metal beam as is customary. The lifting system 24 can be used to carry heavy loads such as drive shafts (not shown), traction motors (not shown), inverter cabins (not shown), etc.

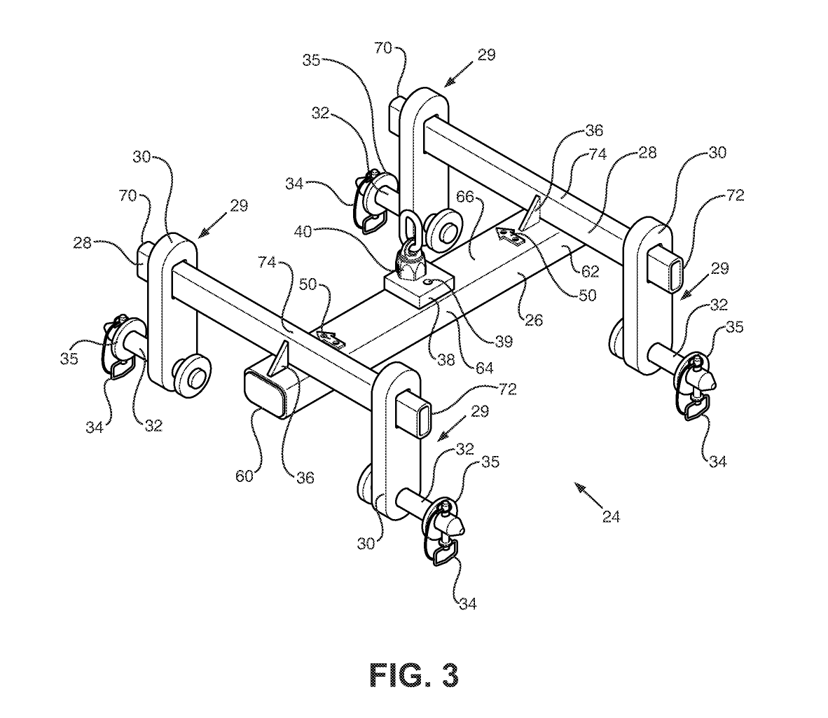

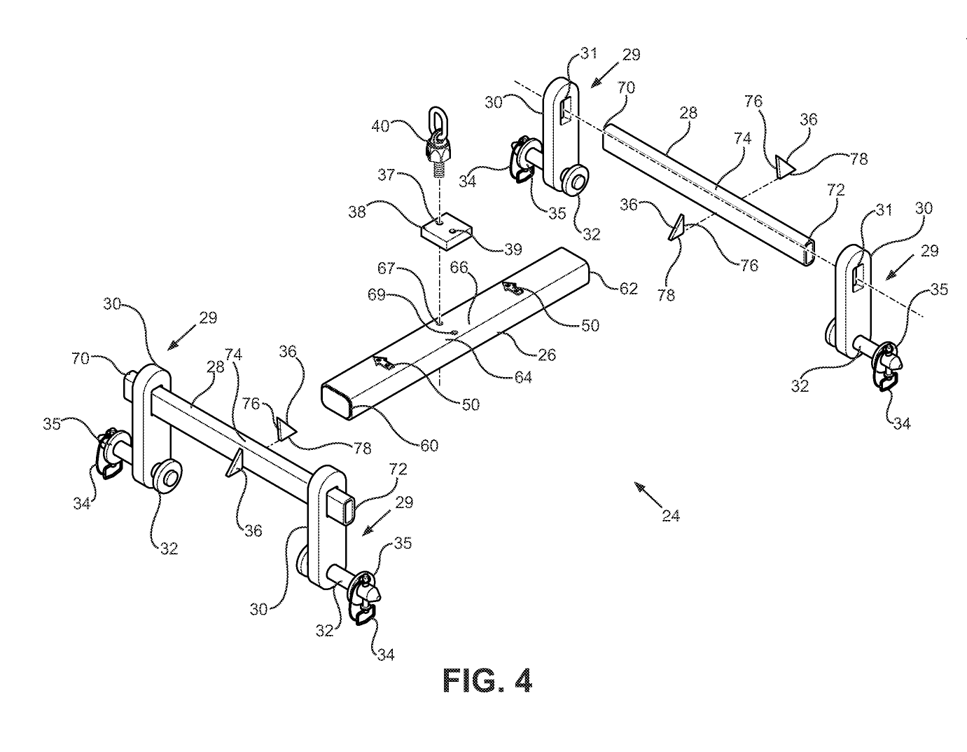

Referring to FIG. 3, the lifting system 24 will now be described. Lifting system 24 may include a rectangular frame rail 26, having a first end 60 and a second end 62 and a center portion 64. The frame rail 26 is a significant structural member and is attached substantially perpendicular with two cross members 28. It is envisioned that cross members 28 could be welded to respective first and second ends 60, 62 of the frame rail 26 by any other method known to those having ordinary skill in the art. Each cross member 28 has a first end 70 and a second end 72 and a middle section 74. The first end 60 of frame rail 26 is connected to the middle section 74 of each cross member 28 and the second end 62 of frame rail 26 is connected to the middle section 74 of the other cross member 28. Attachment assemblies 29 are connected to each end 70 and 72, respectively of the pair of cross members 28 providing four attachment assemblies 29 for lifting system 24. Each of the four attachment assemblies 29 has an extension link 30 with a rectangular aperture 31 (FIG. 4), to accommodate the ends 70, 72 of the pair of cross members 28 extending therethrough.

Referring to FIG. 4, it may be seen that four triangular shaped gussets or support members 36 are configured to each have two adjacent edges, i.e. first end 76 and second end 78 therein that are generally orthogonal to one another. Each support member 36 is welded along the intersection of the support member 36 and the cross member 28 and along the intersection of the support member 36 and the frame rail 26 at the specified first end 76 and second end 78 of each support member 36 (FIG. 3). The support members 36 provide additional support and rigidity to the lifting system 24. Frame rail 26 includes mounting face 66 and orientation arrows 50 (FIG. 4) attached to the mounting face 66 to aid a service person assembling the lifting system 24 to the alternator 22 to ensure the lifting system 24 is properly oriented relative to a front 79 of the alternator 22 (FIG. 2).

Referring again to FIG. 4, the center portion 64 of the frame rail 26 may have two distinct and alternatively used threaded holes 67, 69, placed to coincide with different size alternators. Since each alternator is likely to have its own specific center of gravity the threaded holes 67 and 69 correspond with different size alternators each having distinct centers of gravity. Thus, the proper threaded hole 67, 69 can be selected and used to lift the lifting system 24 to insure that the frame rail 26 (and alternator shaft alignment) remains relatively horizontal during lifting. A mounting plate 38 having mounting holes 37, 39, may be attached, by welding for example, to the mounting face 66 of the center portion 64 of frame rail 26 such that the first mounting hole 37 is in line with first threaded hole 67 and the second mounting hole 39 is in line with the second threaded hole 69. In an exemplary embodiment, the mounting plate 38 may be made up of hardened steel and the mounting holes 37, 39 may be threaded, to provide additional strength and positive thread engagement for the lifting system 24. A lifting lug assembly 40, which may be connected to the mounting holes (37 or 39), is hereinafter described.

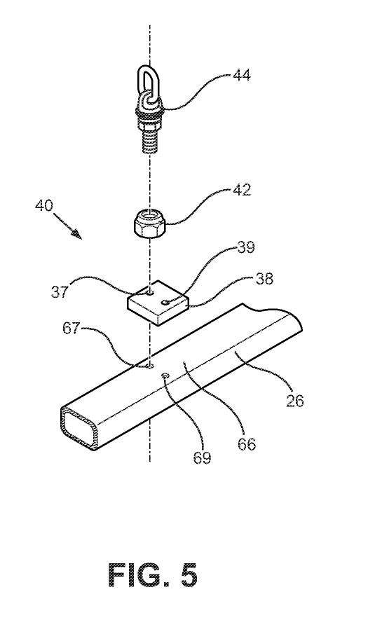

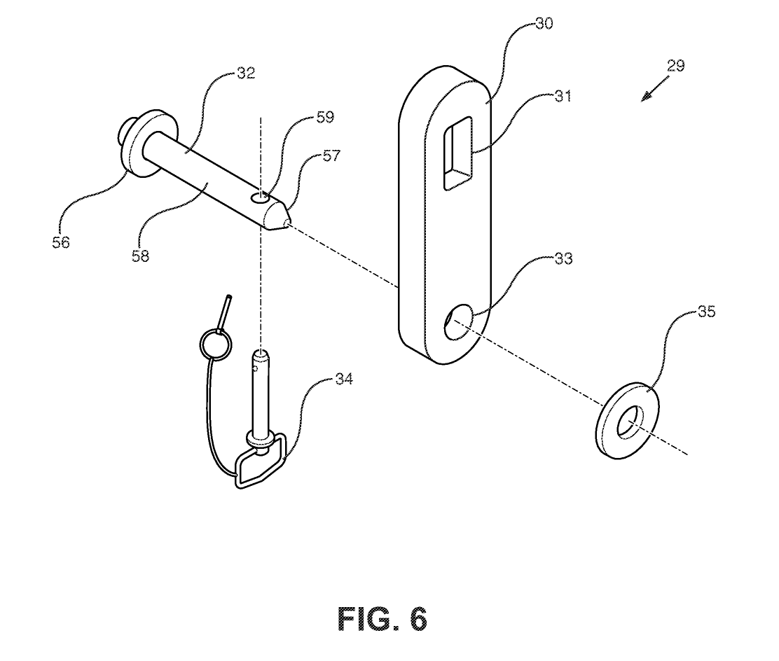

Referring to FIG. 5, the lifting lug assembly 40 may include a lifting lug or eye-bolt type threaded fastener 44 (“eye bolt 44”), such that the eye-bolt 44 has a single chain link adapted to connect to a hook at the end of a the chain 46 (shown in FIG. 2) of the hoist 49, as is customary. The thickness of mounting plate 38 may be selected, such that an appropriate number of threads are engaged between the eye-bolt 44 and mounting plate 38, for a full threaded bolted joint connection. The strength of bolted joint connection thus formed may depend on the size of thread on eye-bolt 44, which may in turn depend on the weight of the object to be lifted. Referring to FIG. 6, the lifting system 24 has four attachment assemblies 29 (FIG. 3), however further explanation of each attachment assembly 29 may be best explained with reference to FIG. 6. Each attachment assembly 29 includes an extension link 30, a detachable pin member 32, a lock pin 34 and a washer 35. The pin member 32 is slidably engaged with the extension link 30 through an aperture 33 formed in the extension link 30. The pin member 32 includes first end 56, second end 57, and middle portion 58. At a location toward end 57 of the middle portion 58 of pin member 32 is a radially positioned hole 59. The first end 56 of pin member 32 includes a head as is customary and the second end 57 has the hole 59 to receive lock pin 34 to ensure pin member 32 is properly retained in extension link 30. The pin member 32 is of sufficient length to passthrough both sides of a mounting bracket 80 provided on alternator 22 (FIG. 2).

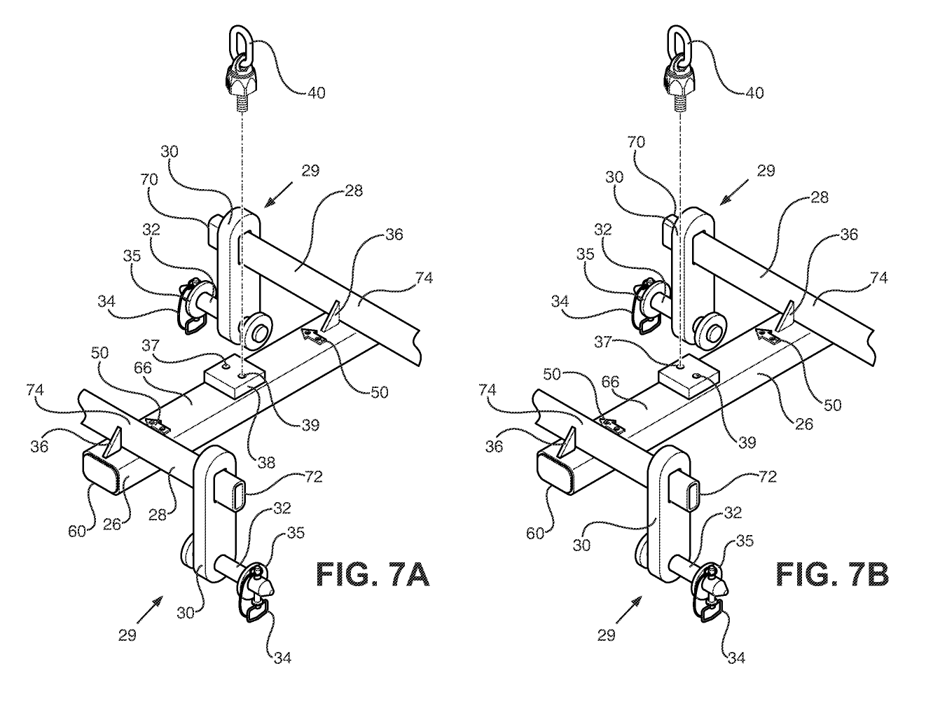

Referring now to FIG. 7A and FIG. 7B, the alternative mounting options for lifting lug assembly 40 will now be described. In FIG. 7A, the lifting lug assembly 40 may be fastened into mounting hole 39 for a first type of alternator 22 (FIG. 2). Alternatively, and as shown in FIG. 7B, lifting lug assembly 40 may be fastened into mounting hole 37 for a second type of alternator 22 (FIG. 2).

As best seen in FIG. 3, the assembly of the exemplary lifting system 24 will now be described. The connection between: frame rail 26 and cross members 28,; cross member 28 and each of the attachment assemblies 29,; support members 36 and frame rail 26 and cross member 28 are metal to metal connections perhaps carbon steel and permanently affixed by welding all abutting connection points. Alternatively the aforesaid connections can be permanently fixed by fastening or any other permanent fastening technique known by those having ordinary skill in the art of joining materials similar or dissimilar materials.

In an exemplary embodiment, the structural components such as frame rail 26 and cross members 28 may be made out of readily available rectangular bar stock or rectangular tube stock having a rectangular or square cross-section and being made from carbon steel or other type of commonly available material with suitable structural integrity. Other types of materials known to those with ordinary skill in the art that could be used to construct the structural members of the lifting system 24 are contemplated by the present disclosure.

### INDUSTRIAL APPLICABILITY

The lifting system 24, described above is economical, lighter in weight, easily manufacturable and made out of inexpensive and readily available material. The construct of lifting assembly 24 is designed such that substantially all of the permanently fixed (i.e., welded) joints in the structural members are in compression such that the quality of the welds will have little or no effect on the overall integrity of the lifting system. For example, lifting force acing on the lifting lug assembly 40, transmits through various structural members to the mounting location (not shown) of the alternator 22, such that there is a compressive force between the frame rail 26 and cross members 28 or between cross members 28 and the connected attachment assembly 29. The design of the lifting system 24 as described above may be easier to manufacture, assemble and yield a higher integrity system resulting in an improved life due to the compressive forces as described. In particular, the customary service trucks used in the fields have a particular weight lifting capacity and are often times much shorter in height compared to a mining truck, such as the one illustrated in this disclosure. Therefore, a lightweight, low profile and simple lifting system is disclosed above, that can easily maneuver into the space available between the load body and chassis and the lifting system is easy to assemble/disassemble to the hoist of the service truck and the alternator or component to be lifted. The lifting system is constructed of a relatively light weight structure and one that is easy to manufacture and assemble.

Referring to FIG. 2, in operation to remove the alternator 22 assembled on a machine, such as an off-highway truck 10 with its load body 18 lifted, the lifting system 24 may be linked to the hoist 49, by attaching the eye-bolt 44 of lifting lug assembly 40 to the chain 46. The foundational member 48 and the hoist 49 are adjusted such that the lifting system is moved and placed over the alternator 22. At each corner of the lifting system 24, the lock pin 34 is temporarily removed, and the pin member 32 is inserted through the extension link 30, such that the second end 57 of each pin member 32 passes through each saddle or mounting bracket 80 on the alternator 22. The box-type mounting brackets 80 fixed on the alternator may be constructed, as is customary, from suitable gage thickness carbon steel plate and welded together and permanently affixed to the outer portion of the alternator 22 in four places. To secure each attachment assembly 29 to each mount 80 on the alternator 22, each washer 35 is inserted over an associated pin member 32 and a lock pin 34 is inserted through each radial hole 59 in the pin member 32, such that the extension link 30, mount 80 on the alternator 22, and washer 35 are sandwiched between each lock pin 34 and the first ends 56 of each pin member 32. The same procedure is repeated on remainder of the three attachment assemblies 29, to secure the alternator 22 with the lifting system 24. When all four lock pins 34 are in place within the pin members 32, the hoist 49 is operated to lift the alternator 22 along with the lifting system 24 and moved to desired location. To remove the lifting system 24 from the alternator 22 once the alternator 22 is safely resting in its final destination, the lock pins 34 are removed and the pin members 32 are then removed. Thereafter the lifting system 24 may be moved out of place with the hoist 49.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A lifting system for use with a hoist to exert an upward force on the lifting system associated with the lifting of a load, comprising:
a frame rail having first and second ends and a center portion extending therebetween, said frame rail defining a mounting face on said center portion;
a first cross member having a first end and a second end and a middle section therebetween, the middle section of said first cross member being attached to the mounting face of said frame rail at a position of the frame rail proximate to said first end of the frame rail;
a second cross member having a first end and a second end and a middle section therebetween, the middle section of said second cross member being attached to the mounting face of said frame rail at a position of the frame rail proximate to said second end of the frame rail;
a first pair of attachment assemblies, each of said first pair of attachment assemblies having an extension link, each said extension link defining an aperture on a first end of said extension link and a pin receiving portion on a second end of said extension link, the first end of the first cross member extending therethrough the aperture of one of the extension links and being affixed to the first end of said one of the extension links, the second end of the first cross member extending therethrough the aperture of the other of said extension links and being affixed to the first end of said other of the extension links, the pin receiving portions of each of the extension links structured and arranged to receive a detachable pin member therethrough;
a second pair of attachment assemblies, each of said second pair of attachment assemblies having an extension link, each said extension link defining an aperture on a first end of said extension link and a pin receiving portion on a second end of said extension link, the first end of the second cross member extending therethrough the aperture of one of the extension links and being affixed to the first end of said one of the extension links, the second end of the second cross member extending therethrough the aperture of the other of said extension links and being affixed to the first end of said other of the extension links, the pin receiving portions of each of the extension links structured and arranged to receive a detachable pin member therethrough;
a lifting lug assembly, have a first attachment portion and a second attachment portion, the said first attachment portion being structurally attached to the mounting face of the center portion of said frame rail and the second attachment portion structured and arranged to attach a hoist system thereby;
wherein the rail frame is structured and arranged to be in compressive force contact with the first and second cross members and the first and second cross members are structured and arranged to be in compressive force contact with each of the extension links of the first and second pairs of attachment assemblies in response to the load being applied to the attachment assemblies and corresponding upward force on the lifting lug assembly.

2. The lifting system of claim 1, wherein the said frame rail having at least one threaded hole on the mounting face in proximity to the center portion of the said frame rail, the threaded hole is structured and arranged to attach the first attachment portion of the lifting lug assembly

3. The lifting system of claim 1, wherein a mounting plate with at least one threaded hole is integrally attached to the mounting face of the center portion of the frame rail, threaded hole of the mounting plate structured and arranged to attach the first attachment portion of the lifting lug assembly.

4. The lifting system of claim 1, wherein said detachable pin member, having a first end, a second end, a middle portion and a pin securement portion, first end of said pin member structurally attached to the pin receiving portion of the said extension link, middle portion of said pin member structurally attached to the lifting object extending therethrough, the second end of the detachable pin member having a radial hole through the middle portion of pin member extending therethrough, and the pin securement portion structurally attached to the radial hole of middle portion therethrough.

5. The lifting system of claim 1, wherein at least one orientation member, integrally attached to the frame rail or to any one of the cross members, indicating the orientation of the lifting system.

6. The lifting system of claim 1, wherein cross-section of said frame rail and said cross members, may be made in rectangular or circular form.
